(19) United States
(12) Patent Application Publication
(10) Pub. No.: US 2005/0278252 A1
(43) Pub. Date: Dec. 15, 2005

(54) Method for balance sheet adjustment with financial investment capabilities

(76) Inventor: Barney Richmond, Jupiter, FL (US)

Correspondence Address: NORMAN FRIEDLAND, 2855 PGA BOULEVARD, SUITE 200, PALM BEACH GARDENS, FL, 33410, US

(21) Appl. No.: 10/856,976

(22) Filed: May 28, 2004

(51) Int. Cl. G06F 17/60

(52) U.S. Cl. 705/40

(57) ABSTRACT

A PLAN and SPECIAL PLAN are disclosed which are business methods for allowing a business to include in its financial statement an asset to counterbalance the liability that is reported on the financial statement that reflects the unused vacation payments, unused sick benefit payments, future pension payments and the like obligated by the business. The method includes the forming of a pool of employees and providing a qualified tax plan and purchasing paid-up whole life or term insurance and naming the employer as the death beneficiary. The SPECIAL PLAN is the treatment of tax consequences of the Social Security taxes paid by the employer. This amount of tax payment is eliminated when the pool of employees make a mandatory contribution of a specific amount of funds.

### FEDERALLY SPONSORED RESEARCH

None

### CROSS REFERENCE TO RELATED APPLICATION

None

### TECHNICAL FIELD

This invention relates to the business method of adjusting the balance sheet of a business organization and particularly to a system for organizing the unfunded obligations of the business organization so that what would otherwise be a liability on the balance sheet or financial reports becomes an asset and the system for providing the investing capability to enhance the profitability of the business organization and the improved treatment of tax obligations.

### BACKGROUND OF THE INVENTION

As is well known by those skilled in accounting practices, the amount of monies that are required to pay for unused sick leave, unused vacation pay, future pension payments of employees of a business organization, and other post employment benefits (all referred to as OPEB) is essentially a liability that is incurred by the business organization. Heretofore, this liability was not evidenced in the balance sheet of that business organization, notwithstanding the fact that these monies would have to be paid at some time. In the near term, by the dictates of governmental legislation, these accrued liabilities will be listed on the balance sheet and as such, would obviously affect the financial health of that business corporation and typically, in an adverse manner. As for example, as a liability the value of a company is decreased and this decrease can effect the rating of a company and hence, the interest it may have to pay for loans, the possibly increase in insurance premiums and the like. This mandate will require the following changes:
1) to accurately measure the cost of benefits and recognize the OPEB expense on the accrual basis of accounting in periods that approximate the employee's years of service;
2) provide accurate information about the actuarial accrued liabilities for promised benefits associated with past services and whether, and to what extent, those benefits have been funded; and
3) provide accurate information useful in assessing potential demands on the employers future cash flows.

This invention addresses this problem by not only enhancing the value of that business organization as viewed from its balance sheet, but also allowing that business organization to enjoy income gained by financial investments made in accordance with this invention coupled with the proper treatment of the employee's accrued income and the solution to certain tax consequences that are normally associated with doing business. This invention will have an effect of allowing one to have transparency of a company's health as it impacts its bond ratings and will allow insurance providers of agencies, like municipal, state and school boards (such as the Municipal Bond Insurance, to have more visibility in reviewing the true liabilities of the business in question. Obviously, this will have an impact on the credit rating of a business including many municipalities, state governments, school boards and other agencies, with a consequential increase in its borrowing costs so as to impact the value of its bonds or securities, etc.

I have found that I can provide a method that would reduce the liability assessed in the financial statement or balance sheet by forming a pool of volunteer employees who will agree to be insured in a particular format with the employer paying the premiums for the insurance and being the beneficiary of each of the employees' policies. For example, a pool of 100 employees agreeing to be insured under a paid up whole life insurance policy with a death payment of one million dollars each ($ 1,000,000), the combined value of the 100 policies ($ 100,000,000) would be carried as an asset on the balance sheet. For the sake of simplicity and convenience this example does not consider the actuarial determination of each of the employees. Assuming the premiums are two million dollars ($2,000,000) per year, a portion of this amount can be used as security for securing a loan and that portion which, say, is between 93%-94%, increases each year. Hence, if the unfunded liability of the OPEBs is equal to the cash value of the policies, the financial statements will not reflect a liability since these values offset each other. It should be pointed out that the financial package of this invention requires that the employees enter into a qualified plan accepted by the government with their employer.

In addition, in accordance with this invention I provide a method so that with a qualified plan the employer can save the required social security and medicare taxes. Under this plan, a government employee must contribute a percentage of his salary (say, 7.5%) which can be funded by the employee's contribution, the employer's contribution or a combination of both. When the employer makes the contribution, the employer will not have to pay the social security taxes, i.e. FICA payments, to the government. Of course, the government employee's contributions must participate in a tax qualified retirement plan where these contributions are contributed before the tax withholdings are calculated, with the taxes on the earnings being deferred until withdrawal begins.

By combining the insurance plan with the tax savings plan, an employer, if contributing the employee's mandatory percentage to the plan and offsetting the OPEB, the employer could eventually gain a positive cash flow after a given period of time notwithstanding the fact that the employer has made a small out of pocket expense in the beginning years while engaged in the method of this invention.

### SUMMARY OF THE INVENTION

An object of this invention is to provide a method (the PLAN) for including in the financial statement of certain businesses, an asset that reduces the amount of liability that would otherwise be carried to reflect the unfunded liabilities of the business's OPEBs.

A feature of this invention included under the PLAN is the method of forming a pool of employees of a business and obtaining a paid-up whole life or term insurance policy for each employee with the business being the beneficiary and utilizing its value, as calculated with actuarial standards, as an asset of that business.

Another feature of this invention under the PLAN is for the business to utilize the a portion, i.e. a percentage, of the payment of the premiums for the paid up whole life or term insurance policy which is an expense, as a security for securing loan(s) and the percentage increases with each passing year.

Another feature of this invention is the provision of a SPECIAL PLAN for government employers which is a combination of the PLAN wherein each employee funds a predetermined amount into the PLAN so that the government employer's tax consequence for social security and medicare is waived when the employee's regulated contribution is invested in a tax qualified retirement plan.

The foregoing and other features of the present invention will become more apparent from the following description.

### DETAILED DESCRIPTION OF THE INVENTION

For the purpose of this invention the following definition will apply:

OPEB—are other (other than future pension payments) post employment benefits, such as unused sick pay, vacation pay, etc. that accrue for the benefit of government employees.

PLAN—this is a business method that allows an employer to carry paid-up whole life or term insurance for each of a pool of employees whose premiums are paid by the employer who is the named beneficiary in the policy which value, as calculated by standard actuary considerations, serves as an asset to the company's financial statement.

SPECIAL PLAN is a business method in combination with the PLAN that allows the government employer and employee to forego the payment of certain social security and medicare taxes under a given set of circumstances.

This invention is a business method that creates a financial product that is usable by certain business that typically includes pension payment liabilities for its employees and/or OPEBs. Essentially, the PLAN creates a pool of employees that accept paid-up whole life or term insurance policy(ies) that are paid for by the employer. The employer is named as the beneficiary thereof. Hence, the cash value of the policy(ies), as calculated using standard actuarial criteria, can now by used as an asset on the company's financial statements or balance sheet. Also, a given percentage of the premiums is considered as an asset that contributes to the ability of the businesses to obtain loans and to the amount of the loan. The percentage of these premiums increases each year until all the premiums for the paid-up whole life or term insurance policy(ies) are paid. By virtue of this invention a businesses or organizations, particularly, municipalities, school boards and other governmental agencies, establishing this PLAN and/or SPECIAL PLAN will enhance the financial statement by decreasing the liability and increasing the assets so as to, perhaps, be able to borrow money at a reduced rate, reduce insurance coverage costs with respect to insuring government entities bonds, and increase the value of its outstanding or newly issued bonds.

The SPECIAL PLAN when combined with the PLAN takes advantage of certain tax legislation for government employees which allow employers and employees, using a qualified plan as is the case in the PLAN to save the current tax rate of 6.2% of Social Security taxes and 1.45% of Medicare taxes when contributions are made in the SPECIAL PLAN. Also, mandatory employer contributions up to the allow amount of $41,000 can be made to the SPECIAL PLAN and employees can invest unused sick pay, vacation pay, and the like. The SPECIAL PLAN allows the employer to reduce the employer's payroll will be able to save the current taxes (FICA). Like in the PLAN, the employee contributions have to be invested in a qualified retirement plan (governmental regulations) and these contributions are contributed before the tax withholding is calculated with the taxes on the earnings being deferred until withdrawn or in the case of an annuity investment, when the annuity payout begins.

Although this invention has been shown and described with respect to a detailed business method, it will be appreciated and understood by those skilled in the art that various changes in form and detail thereof may be made without departing from the spirit and scope of the claimed invention.

1. The business method of balancing the amount of liability incurred by unused sick pay, vacation pay, pension pay of an employee as reported on a business's financial statement by making a financial investments so as to offset the liability reported on the financial statement to an asset including the steps of:
i) forming a pool of employees;
ii) establishing a qualified retirement plan for each of the employees of the pool formed in step I);
iii) purchasing a paid-up whole life insurance policy covering the life of each member of the pool of employees formed in step I) and making the employer the sole beneficiary of said insurance policy;
iv) making payments of the premiums to the carrier of the insurance associated with the insurance policy of step ii); and
v) assigning the value of the total death benefits of the insurance policy in step I) in the financial statement as an asset to the business's balance sheet.

2. The method of claim 1 including funding the qualified retirement plan of step ii) by the employees of the pool established in step I);
vi) applying a mandatory contribution to the plan of a specific amount of money,
whereby, the employer avoids the payment of the social security taxes on these amounts contributed in step vi).

3. The business method of balancing the amount of liability incurred by unused sick pay, vacation pay, pension pay of an employee as reported on a business's financial statement by making a financial investments so as to offset the liability reported on the financial statement to an asset including the steps of:
i) forming a pool of employees;
ii) establishing a qualified retirement plan for each of the employees of the pool formed in step I);
iii) purchasing a term insurance policy covering the life of each member of the pool of employees formed in step I) and making the employer the sole beneficiary of said insurance policy;
iv) making payments of the premiums to the carrier of the insurance associated with the insurance policy of step ii); and
v) assigning the value of the total death benefits of the insurance policy in step I) in the financial statement as an asset to the business's balance sheet.

4. The method of claim 1 including funding the qualified retirement plan of step ii) by the employees of the pool established in step I);
vi) applying a mandatory contribution to the plan of a specific amount of money,
whereby, the employer avoids the payment of the social security taxes on these amounts contributed in step vi).
